(19) United States
(12) Patent Application Publication
(10) Pub. No.: US 2024/0238733 A1
(43) Pub. Date: Jul. 18, 2024

(54) Preparation Method for Hollow Fiber Inorganic Membrane

(71) Applicant: Harbin Institute of Technology, Harbin City, Heilongjiang Province (CN)

(72) Inventors: Jun MA, Harbin (CN); Dongwei LV, Harbin (CN); Hui ZHANG, Harbin (CN)

(21) Appl. No.: 18/557,121

(22) PCT Filed: Mar. 1, 2022
(86) PCT No.: PCT/CN2022/078518

§ 371 Date: Oct. 25, 2023

(30) Foreign Application Priority Data
Apr. 25, 2021 (CN) 202110463438.3

(51) Int. Cl. B01D 67/00; B01D 71/02

(52) U.S. Cl. CPC B01D 67/0079; B01D 67/0093; B01D 71/021; B01D 2325/10

(57) ABSTRACT

A preparation method for a hollow fiber inorganic membrane to solve the problem that the existing membrane technology cannot simultaneously have high flux and a high retention rate, including the steps of: adding an inorganic material, a polymer, and a binder into an organic solvent, first performing ball milling, and then vacuumizing to obtain a casting solution; using tap water as an internal coagulant, spinning the casting solution, then using tap water and/or the organic solvent as an external coagulant, putting membrane filaments in the external coagulant, performing phase inversion under 19.5-20.5° C., taking out the membrane filaments, and then drying same to obtain a basement membrane green body; and calcining the basement membrane green body at 800-950° C. to obtain a hollow basement membrane, and preparing a separation layer on the outer surface of the hollow basement membrane to obtain the hollow fiber inorganic membrane.

### BACKGROUND OF THE PRESENT INVENTION

### Field of Invention

The present invention relates to a preparation method for hollow fiber inorganic membrane.

### Description of Related Arts

Membrane separation technology refers to a technology that selectively separates molecules of different particle sizes through the selective permeability of the membrane under a certain driving force (pressure difference, concentration difference, potential difference, or temperature difference). Compared with other separation methods, membrane separation technology has the advantages of high energy efficiency, simple equipment, good flexibility, small footprint and easy implementation in industrial applications. Membrane separation technology is simple to operate, generally able to be carried out at room temperature, and more economical. During the separation process, relatively less energy is consumed while no secondary pollution is produced. It has a wide range of applications, and separation can be achieved for general inorganic substances, organic substances to bacteria, etc. The pore size of the membrane can also be selected according to the separation goal to achieve selective separation and recover useful substances. The process is simple, can be expanded in scale more easily, and can be easily implemented in industrial applications.

Membrane materials with excellent performance in all aspects are the key to membrane separation technology. Materials that can be used as membranes are very common. Natural and synthetic organic polymer materials and inorganic materials can be used as base membranes. Theoretically, all inorganic materials and polymer materials that can form films can be used to prepare the membrane. Organic membrane materials have the advantages of wide variety, relatively low price, and easy processing, and have occupied a considerable proportion of market share. However, organic membranes have inherent disadvantages: low thermal stability and chemical resistance, which severely limits their use under extreme conditions (such as higher temperatures, lower or higher pH, and corrosive organic chemicals. Operation), and organic membranes are easy to scale and have short service life, thus restricting the application of organic membranes.

Compared with organic membranes, inorganic membranes have the following technical advantages: high porosity, good separation and high flux volume; better thermal, mechanical and chemical stability and longer membrane life; as well as better hydrophilicity, high flux volume at low pressure and less prone to fouling (scaling). Although the market for inorganic membranes in industrial applications and academic research is relatively small, the application of inorganic membranes in water and wastewater treatment has attracted global attention due to the unique properties of inorganic materials. Among ceramic membranes with different geometric shapes, hollow fiber membranes are attracting more and more attention. This is because, compared with flat membranes, it has an extremely high packing density and can obtain the largest membrane area per unit volume.

The increasing demand for efficient water separation, the easier availability of new materials, and a deeper understanding of the structural properties and mechanisms of membranes have made it possible for inorganic separation membranes to have excellent permeability and selectivity, hence inducing extensive research aimed at overcoming the permeability/selectivity trade-off. All synthetic membranes require a trade-off between permeability and selectivity. In addition, there are numerous practical challenges such as membrane fouling, degradation, and material failure which limit their use. It is necessary to study membrane materials with better mechanical properties, chemical resistance, thermal stability, permeability and selectivity, and to explore the relationship between membrane preparation parameters and structural properties as well as the mechanism of pollutant removal. Based on the development of molecular-level theory of synthetic membranes, the key design criteria for membranes can be summarized as: 1. Free volume elements (or pores) of suitable size; 2. Narrow free volume element (or pore size) distribution; 3. Thin active layer, 4. Highly regulated interactions between permeate and membrane.

Therefore, there is an urgent need for a simple and versatile membrane technology that can achieve efficient water treatment at low operating pressures. But for now, this is still a very difficult challenge.

### SUMMARY OF THE PRESENT INVENTION

An object of the present invention is to provide a method for preparing a hollow fiber inorganic membrane to solve the problem that existing membrane technology cannot achieve both high membrane flux and high rejection rate of the membrane.

A method for preparing a hollow fiber inorganic membrane according to the following steps:

adding an inorganic material, a polymer and a binder in an organic solvent to form a mixture, ball milling for 18-24 hours, then vacuuming 24-48 hours to obtain a casting liquid solution; using tap water as an internal coagulant, spinning the casting liquid solution by a spinneret and a syringe pump to obtain a membrane filament; using tap water and/or an organic solvent as an external coagulant, placing the membrane filament into the external coagulant and carrying out phase inversion under a temperature condition of 19.5-20.5° C. for 24-48 hours, then taking out and drying for 24-48 hours to obtain a base membrane raw body; carrying out calcination of the base membrane raw body under a calcination temperature condition of 800-950° C. for 1-2 hours to obtain a hollow base membrane; and preparing a separation layer on an outer surface of the hollow base membrane by using electrochemical deposition method, sol-gel method or chemical vapor deposition method to obtain the hollow fiber inorganic membrane.

The advantageous effects of the present invention are as follows:
1. The present invention is a preparation method of hollow fiber inorganic membrane, which utilizes the conductivity of the metal film to carry out surface modification through electrochemical deposition and grows metal-organic frameworks (MOFs) on hollow fiber inorganic conductive membranes to obtain an isoporous inorganic membrane with high flux and high porosity. MOF membranes have excellent ion selectivity and can effectively separate equivalent alkali metal ions. The pore size and special structure of the pores can be adjusted to provide high membrane flux and eliminate the trade-off between high flux and selectivity of the membrane. The membrane is conductive and can be assisted by a micro-electric field to assist the molecular dynamics system by coupling the micro-electric field, utilizes electrostatic repulsion and cathodic protection mechanisms to achieve higher membrane flux, higher rejection rate, longer membrane life and excellent anti-fouling performance, breaking through the trade-off between membrane flux and rejection rate.
2. The present invention is a preparation method of hollow fiber inorganic membrane, which is a combination of membrane technology and advanced oxidation technology (AOPs). An effective strategy to improve the removal efficiency of organic pollutants in low-pressure membrane filtration processes is to combine with AOPs. Hollow fiber inorganic catalytic membranes are made using AOPs catalysts as raw materials and membrane technology is combined with advanced oxidation technology to achieve good water treatment effects. Natural organic matter (NOM) is ubiquitous in water sources and cannot be completely removed by conventional water treatment processes. As a free radical scavenger, it can consume a large amount of oxidizing free radicals, and can also be adsorbed on the surface of the catalyst and block reaction sites. The catalytic oxidation membrane can effectively eliminate the adverse effects of NOM on the advanced oxidation process by relying on its superior separation performance. The catalytic oxidation membrane has excellent separation performance and efficient oxidation performance.
3. The separation layer of the anti-pollution conductive catalytic filtration multifunctional hollow fiber membrane of the present invention can also be made of carbon materials, such as carbon nanotubes and graphene oxide. A base membrane is prepared using metal oxides as inorganic raw materials, and a carbon nanotube separation layer is constructed in situ on the surface of the base membrane through dip coating and autocatalytic chemical vapor deposition, and the metal oxide base membrane can provide hydroxyl groups as active sites for nanocatalysts for in-situ growth of carbon nanotubes. Or the ceramic hollow fiber inorganic membrane fixes graphene oxide on the surface of the base membrane through a simple vacuum filtration method. The hollow fiber inorganic membrane covered with carbon material coupled to the micro-electric field has high and stable membrane flux and high rejection rate through the cathodic protection mechanism and has excellent thermal stability and mechanical strength.
4. According to the present invention, a wide range of materials can be used for membrane substrate, which ranges from metals, metal oxides to industrial waste. It has a wide range of sources and has a low cost. It can also treat waste with waste and is more suitable for industrial production.
5. The hollow fiber inorganic membranes of the present invention have high flux, high rejection rate, high stability and strong anti-pollution properties. Compared with flat membranes, they have extremely high packing density and are industrially practical.

According to the present invention, a preparation method of hollow fiber inorganic membrane can be obtained.

### BRIEF DESCRIPTION OF THE DRAWINGS

FIG. 1 is an SEM image of the stainless steel-based hollow base membrane prepared in Embodiment 1.

FIG. 2 is an energy spectrum diagram of the stainless steel-based hollow base membrane prepared in Embodiment 1.

FIG. 3 is a diagram showing the distribution position of Cr on the stainless steel-based hollow base membrane in FIG. 2.

FIG. 4 is a diagram showing the distribution position of Fe on the stainless steel-based hollow base membrane in FIG. 2.

FIG. 5 is a diagram showing the distribution position of Ni on the stainless steel-based hollow base membrane in FIG. 2.

FIG. 6 is a preparation flow chart of a preparation method for a hollow fiber inorganic membrane according to the present invention.

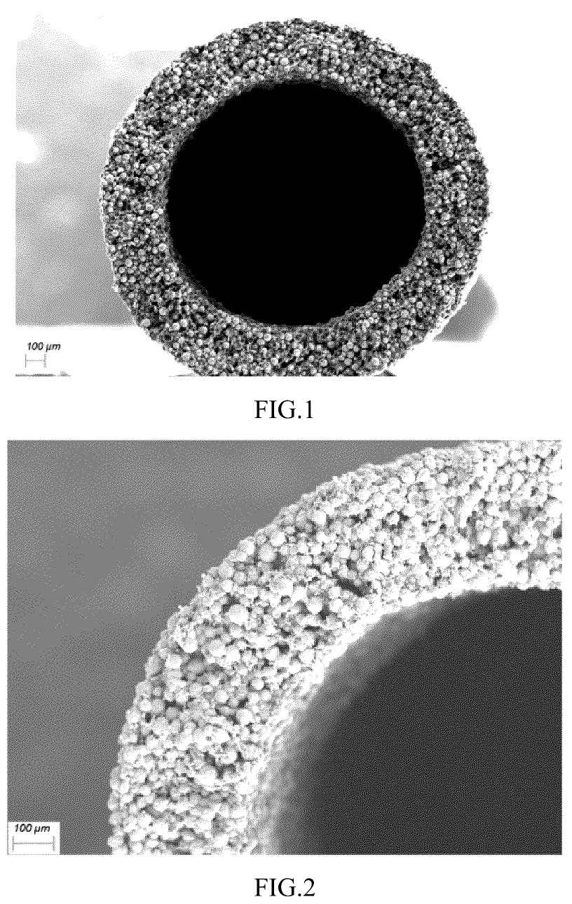

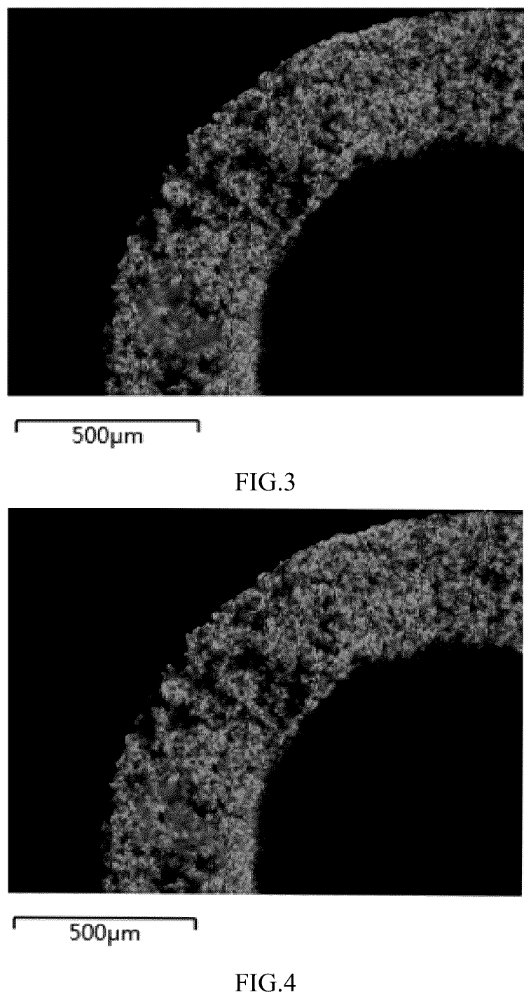

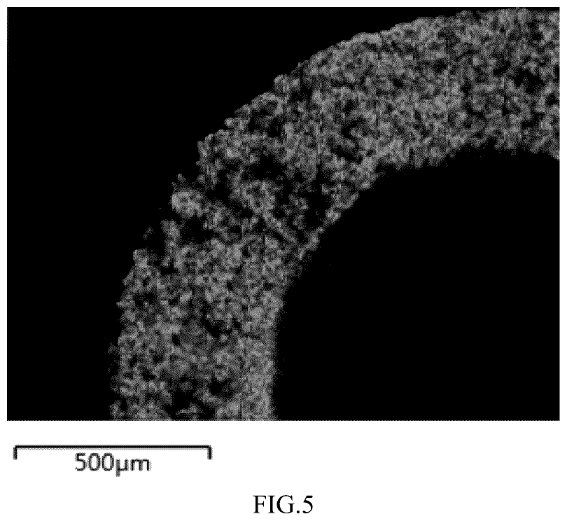

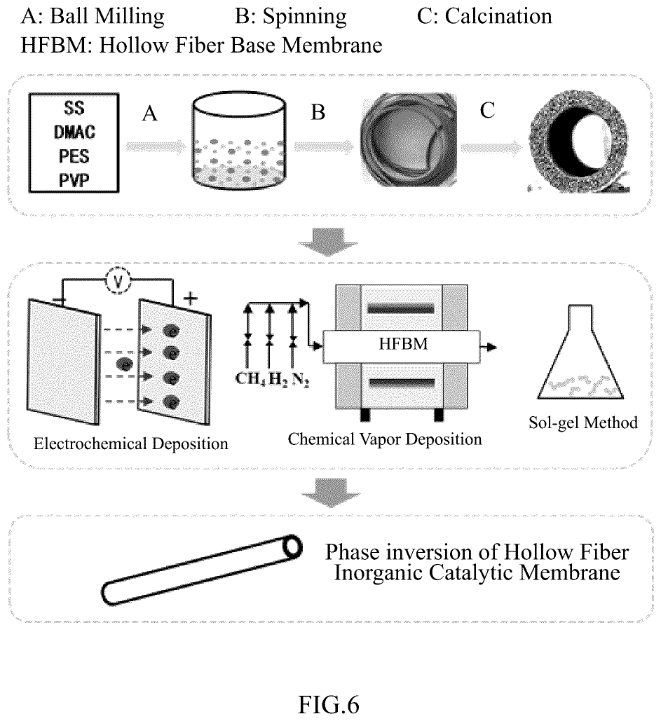

### DETAILED DESCRIPTION OF THE PREFERRED EMBODIMENT

Preferred Embodiment 1: According to this embodiment, a method for preparing a hollow fiber inorganic membrane is carried out according to the following steps:
adding an inorganic material, a polymer and a binder in an organic solvent to form a mixture, ball milling for 18-24 hours, then vacuuming 24-48 hours to obtain a casting liquid solution; using tap water (water) as an internal coagulant, spinning the casting liquid solution by a spinneret and a syringe pump to obtain a membrane filament; using tap water and/or an organic solvent as an external coagulant, placing the membrane filament into the external coagulant and carrying out phase inversion under a temperature condition of 19.5-20.5° C. for 24-48 hours, then taking out and drying for 24-48 hours to obtain a base membrane raw body; carrying out calcination of the base membrane raw body under a calcination temperature condition of 800-950° C. for 1-2 hours to obtain a hollow base membrane; and preparing a separation layer on an outer surface of the hollow base membrane by using electrochemical deposition method, sol-gel method or chemical vapor deposition method to obtain the hollow fiber inorganic membrane.

The advantages of this embodiment are:
1. The preparation method of the hollow fiber inorganic membrane of this embodiment utilizes the conductivity of the metal film to carry out surface modification through electrochemical deposition and grows metal-organic frameworks (MOFs) on hollow fiber inorganic conductive membranes to obtain an isoporous inorganic membrane with high flux and high porosity. MOF membranes have excellent ion selectivity and can effectively separate equivalent alkali metal ions. The pore size and special structure of the pores can be adjusted to provide high membrane flux and eliminate the trade-off between high flux and selectivity of the membrane. The membrane is conductive and can be assisted by a micro-electric field to assist the molecular dynamics system by coupling the micro-electric field, utilizes electrostatic repulsion and cathodic protection mechanisms to achieve higher membrane flux, higher rejection rate, longer membrane life and excellent anti-fouling performance, breaking through the trade-off between membrane flux and rejection rate.
2. The preparation method of the hollow fiber inorganic membrane of this embodiment is a combination of membrane technology and advanced oxidation technology (AOPs). An effective strategy to improve the removal efficiency of organic pollutants in low-pressure membrane filtration processes is to combine with AOPs. Hollow fiber inorganic catalytic membranes are made using AOPs catalysts as raw materials and membrane technology is combined with advanced oxidation technology to achieve good water treatment effects. Natural organic matter (NOM) is ubiquitous in water sources and cannot be completely removed by conventional water treatment processes. As a free radical scavenger, it can consume a large amount of oxidizing free radicals, and can also be adsorbed on the surface of the catalyst and block reaction sites. The catalytic oxidation membrane can effectively eliminate the adverse effects of NOM on the advanced oxidation process by relying on its superior separation performance. The catalytic oxidation membrane has excellent separation performance and efficient oxidation performance.
3. The separation layer of the anti-pollution conductive catalytic filtration multifunctional hollow fiber membrane of this embodiment can also be made of carbon materials, such as carbon nanotubes and graphene oxide. A base membrane is prepared using metal oxides as inorganic raw materials, and a carbon nanotube separation layer is constructed in situ on the surface of the base membrane through dip coating and autocatalytic chemical vapor deposition, and the metal oxide base membrane can provide hydroxyl groups as active sites for nanocatalysts for in-situ growth of carbon nanotubes. Or the ceramic hollow fiber inorganic membrane fixes graphene oxide on the surface of the base membrane through a simple vacuum filtration method. The hollow fiber inorganic membrane covered with carbon material coupled to the micro-electric field has high and stable membrane flux and high rejection rate through the cathodic protection mechanism and has excellent thermal stability and mechanical strength.
4. According to this embodiment, a wide range of materials can be used for base membrane, which ranges from metals, metal oxides to industrial waste. It has a wide range of sources and has a low cost. It can also treat waste with waste and is more suitable for industrial production.
5. The hollow fiber inorganic membranes of this embodiment have high flux, high rejection rate, high stability and strong anti-pollution properties. Compared with flat membranes, they have extremely high packing density and are industrially practical.

Preferred Embodiment 2: The difference between this preferred embodiment and Preferred Embodiment 1 is that: the inorganic material is copper, iron, stainless steel, nickel, manganese oxide or iron oxide, the polymer is polyvinylpyrrolidone, the binder is polysulfone or polyethersulfone, and the organic solvent is N-methylpyrrolidone or N,N-dimethylacetamide, the organic solvent as the external coagulant is ethanol solution.

Other steps are the same as the Preferred Embodiment 1.

Preferred Embodiment 3: The difference between this preferred embodiment and Preferred Embodiment 1 or 2 is that: the inorganic material is stainless steel, the polymer is polyvinylpyrrolidone, the binder is polyethersulfone, and the organic solvent is N,N-dimethylacetamide, a ratio of a mass of stainless steel, a mass of polyvinylpyrrolidone, a mass of polyethersulfone and a volume of N,N-dimethylacetamide is 70 g: 1 g: 5 g: 24 mL, and the base membrane raw body is calcinated under a calcination temperature condition of 950° ° C. for 2 hours to obtain the hollow base membrane.

Other steps are the same as the Preferred Embodiment 1 or 2.

Preferred Embodiment 4: The difference between this preferred embodiment and one of the Preferred Embodiments 1-3 is that: the inorganic material is copper, the polymer is polyvinylpyrrolidone, the binder is polyethersulfone and the organic solvent is N,N-dimethylacetamide, a ratio of a mass of copper, a mass of polyvinylpyrrolidone, a mass of polyethersulfone and a volume of N,N-dimethylacetamide is 71 g: 7 g: 1 g: 21 mL, and the base membrane raw body is calcinated under a calcination temperature condition of 800° C. for 2 hours to obtain the hollow base membrane.

Other steps are the same as the Preferred Embodiments 1-3.

Preferred Embodiment 5: The difference between this preferred embodiment and one of the Preferred Embodiments 1-4 is that: the inorganic material is titanium dioxide, the polymer is polyvinylpyrrolidone, the binder is polyethersulfone and the organic solvent is N,N-dimethylacetamide, a ratio of a mass of titanium dioxide, a mass of polyvinylpyrrolidone, a mass of polyethersulfone and a volume of N,N-dimethylacetamide is 54 g: 5 g: 1 g: 40 mL, and the base membrane raw body is calcinated under a calcination temperature condition of 850° C. for 2 hours to obtain the hollow base membrane.

Other steps are the same as the Preferred Embodiments 1-4.

Preferred Embodiment 6: The difference between this preferred embodiment and one of the Preferred Embodiments 1-5 is that: when the inorganic material is copper, iron, stainless steel, nickel or chromium, a mass fraction of copper, iron, stainless steel or nickel in the mixture of the inorganic material, the polymer, the binder and the organic solvent is greater than 70%.

Other steps are the same as the Preferred Embodiments 1-5.

Preferred Embodiment 7: The difference between this preferred embodiment and one of the Preferred Embodiments 1-6 is that: the hollow base membrane has a pore diameter of 0.4˜1 μm, a porosity of 60˜80%, an inner diameter of 1.2˜1.7 μm, and an outer diameter of 2˜3 μm.

Other steps are the same as the Preferred Embodiments 1-6.

Preferred Embodiment 8: The difference between this preferred embodiment and one of the Preferred Embodiments 1-7 is that: the electrochemical deposition method is carried out according to the following steps: adding 2-methylimidazole to deionized water and mixing uniformly to obtain a solution A, wherein in the solution A, a ratio of a mass of 2-methylimidazole to a volume of deionized water is 4.105 g: 50 mL, and a concentration of 2-methylimidazole is 50 mmol; adding zinc acetate dihydrate to deionized water and mixing uniformly to obtain a solution B, wherein in the solution B, a ratio of a mass of zinc acetate dihydrate to a volume of deionized water is 0.183 g: 10 mL, and a concentration of zinc acetate dihydrate is 0.83 mmol; mixing the solution A and the solution B and stirring for 5 seconds to obtain a ZIF-8 precursor solution; adding the hollow base membrane and a graphite paper into the ZIF-8 precursor solution, keeping a distance between the hollow base membrane and the graphite paper at 1.5 cm, using the graphite paper as an anode, and using the hollow base membrane as a cathode, allowing reaction at a current density of 0.13 m Acm² for 30 minutes, then rinsing by using deionized water and methanol after the reaction is completed to obtain the hollow fiber inorganic membrane.

Other steps are the same as the Preferred Embodiments 1-7.

Preferred Embodiment 9: The difference between this preferred embodiment and one of the Preferred Embodiments 1-8 is that: the sol-gel method is carried out according to the following steps: adding aluminum triethoxide to ultrapure water at 90° C., stirring for 3 hours, adding 1M nitric acid solution, and carrying out reflux at 90° C. for 16 hours to obtain a solution C, wherein a volume ratio of the aluminum triethoxide to the ultrapure water and the nitric acid solution is 67:250:18; adding 1M nitric acid solution and polyvinyl alcohol to ultrapure water, heating and stirring until dissolved to obtain a sol D, wherein a ratio of a volume of the nitric acid solution and the ultrapure water to a mass of polyvinyl alcohol is 5 mL: 25 mL: 3 g; coating the boehmite sol evenly on an outer surface of the hollow base membrane, drying at 50° C. for 24 hours, and then raising the temperature at a heating rate of 0.5° C./min to 540° C. and carrying out calcination at the temperature of 540° ° C. for 4 hours to obtain the hollow fiber inorganic membrane.

Other steps are the same as the Preferred Embodiments 1-8.

Preferred Embodiment 10: The difference between this preferred embodiment and one of the Preferred Embodiments 1-9 is that: the chemical vapor deposition method is carried out according to the following steps: carrying out in situ reduction of the hollow base membrane for 70 min in a mixed gas atmosphere of hydrogen and ethylene at a flow rate of 40 mL/min and at 700° C., then cooling by hydrogen at a flow rate of 20 mL/min to room temperature after the reaction is completed to obtain the hollow fiber inorganic membrane.

Other steps are the same as the Preferred Embodiments 1-9.

The following embodiments are used to verify the advantageous effects of the present invention.

Embodiment 1: A method of preparing stainless steel hollow fiber inorganic membrane is carried out according to the following steps:
adding stainless steel powder, polyvinylpyrrolidone (PVP) and polyethersulfone (PES) in N,N-dimethylacetamide (DMAC) to first obtain a spinning suspension, grinding and mixing the spinning suspension in a ball mill for 24 hours, then vacuuming 24 hours to obtain a casting liquid solution, wherein a ratio of a mass of stainless steel, a mass of polyvinylpyrrolidone, a mass of polyethersulfone and a volume of N,N-dimethylacetamide is 70 g: 1 g: 5 g: 24 mL; using tap water as an internal coagulant, the casting liquid solution being spun by a spinneret and a syringe pump with an air gap 10 cm to obtain a membrane filament (with a size of outer diameter is 2.5 mm, inner diameter is 1.3 mm); then using tap water and/or ethanol solution as an external coagulant, placing the membrane filament into the external coagulant for phase inversion under a temperature condition of 20±0.5° C. for 24 hours to completely solidify, then taking it out and drying for 24 hours to obtain a base membrane raw body; carrying out calcination of the base membrane raw body under a calcination temperature condition of 950° C. for 2 hours to obtain a hollow base membrane, wherein the hollow base membrane has a pore diameter of 0.4˜1 μm, a porosity of 60˜80%, an inner diameter of 1.33 μm, and an outer diameter of 2 μm; and preparing a separation layer on an outer surface of the hollow base membrane by using electrochemical deposition method, sol-gel method or chemical vapor deposition method to obtain the hollow fiber inorganic membrane.

Embodiment 2: A method of preparing copper-based hollow fiber inorganic membrane is carried out according to the following steps:
adding copper powder, polyvinylpyrrolidone (PVP) and polyethersulfone (PES) in N,N-dimethylacetamide (DMAC) to first obtain a spinning suspension, grinding and mixing the spinning suspension in a ball mill for 24 hours, then vacuuming 24 hours to obtain a casting liquid solution, wherein a ratio of a mass of copper, a mass of polyvinylpyrrolidone, a mass of polyethersulfone and a volume of N,N-dimethylacetamide is 71 g: 7 g: 1 g: 21 mL; using tap water as an internal coagulant, the casting liquid solution being spun by a spinneret and a syringe pump with an air gap 10 cm to obtain a membrane filament (with a size of outer diameter is 2.5 mm, inner diameter is 1.3 mm); then using tap water and/or ethanol solution as an external coagulant, placing the membrane filament into the external coagulant for phase inversion under a temperature condition of 20±0.5° C. for 24 hours to completely solidify, then taking it out and drying for 24 hours to obtain a base membrane raw body; carrying out calcination of the base membrane raw body under a calcination temperature condition of 800° C. for 2 hours to obtain a hollow base membrane, wherein the hollow base membrane has a pore diameter of 0.4˜1 μm, a porosity of 60˜80%, an inner diameter of 1.2˜1.7 μm, and an outer diameter of 2˜2.5 μm; and preparing a separation layer on an outer surface of the hollow base membrane by using electrochemical deposition method, sol-gel method or chemical vapor deposition method to obtain the hollow fiber inorganic membrane.

Embodiment 3: A method of preparing titanium dioxide hollow fiber inorganic membrane is carried out according to the following steps:
adding titanium dioxide, polyvinylpyrrolidone (PVP) and polyethersulfone (PES) in N,N-dimethylacetamide (DMAC) to first obtain a spinning suspension, grinding and mixing the spinning suspension in a ball mill for 24 hours, then vacuuming 24 hours to obtain a casting liquid solution, wherein a ratio of a mass of titanium dioxide, a mass of polyvinylpyrrolidone, a mass of polyethersulfone and a volume of N,N-dimethylacetamide is 54 g: 5 g: 1 g: 40 mL; using tap water as an internal coagulant, the casting liquid solution being spun by a spinneret and a syringe pump with an air gap 10 cm to obtain a membrane filament (with a size of outer diameter is 2.5 mm, inner diameter is 1.3 mm); then using tap water and/or ethanol solution as an external coagulant, placing the membrane filament into the external coagulant for phase inversion under a temperature condition of 20+0.5° C. for 24 hours to completely solidify, then taking it out and drying for 24 hours to obtain a base membrane raw body; carrying out calcination of the base membrane raw body under a calcination temperature condition of 850° C. for 2 hours to obtain a hollow base membrane, wherein the hollow base membrane has a pore diameter of 0.4˜1 μm, a porosity of 60˜80%, an inner diameter of 1.2˜1.7 μm, and an outer diameter of 2˜2.5 μm; and preparing a separation layer on an outer surface of the hollow base membrane by using electrochemical deposition method, sol-gel method or chemical vapor deposition method to obtain the hollow fiber inorganic membrane.

The membrane flux and rejection rate are tested on the hollow fiber inorganic membranes prepared in Embodiments 1-3. The test results showed that the hollow fiber inorganic membrane prepared by the present invention when compared to the traditional hollow membrane, has a membrane flux that is greatly improved, and the stable operation time of the membrane is extended by 30˜40%; when compared with the traditional hollow membrane, the rejection rate is increased by 10˜25%. Therefore, the hollow fiber inorganic membrane prepared by the method of the present invention combines the effects of high membrane flux and high rejection rate.

1. A method of preparing hollow fiber inorganic membrane, characterized in that, the method comprising the following steps:
adding an inorganic material, a polymer, and a binder in an organic solvent to form a mixture, ball milling for 18-24 hours, then vacuuming 24-48 hours to obtain a casting liquid solution;
using tap water as an internal coagulant, spinning the casting liquid solution by a spinneret and a syringe pump to obtain a membrane filament;
using tap water and/or an organic solvent as an external coagulant, placing the membrane filament into the external coagulant, and carrying out phase inversion under a temperature condition of 19.5-20.5° C. for 24-48 hours, then taking out and drying for 24-48 hours to obtain a base membrane raw body;
carrying out calcination of the base membrane raw body under a calcination temperature condition of 800-950° C. for 1-2 hours to obtain a hollow base membrane; and
preparing a separation layer on an outer surface of the hollow base membrane by using electrochemical deposition method, sol-gel method, or chemical vapor deposition method to obtain the hollow fiber inorganic membrane.

2. The method of preparing hollow fiber inorganic membrane according to claim 1, characterized in that, the inorganic material is copper, iron, stainless steel, nickel, manganese oxide or iron oxide, the polymer is polyvinylpyrrolidone, the binder is polysulfone or polyethersulfone, and the organic solvent is N-methylpyrrolidone or N,N-dimethylacetamide, the organic solvent as the external coagulant is ethanol solution.

3. The method of preparing hollow fiber inorganic membrane according to claim 1, characterized in that, the inorganic material is stainless steel, the polymer is polyvinylpyrrolidone, the binder is polyethersulfone, and the organic solvent is N,N-dimethylacetamide, a ratio of a mass of stainless steel, a mass of polyvinylpyrrolidone, a mass of polyethersulfone and a volume of N,N-dimethylacetamide is 70 g: 1 g: 5 g: 24 mL, and the base membrane raw body is calcinated under a calcination temperature condition of 950° C. for 2 hours to obtain the hollow base membrane.

4. The method of preparing hollow fiber inorganic membrane according to claim 1, characterized in that, the inorganic material is copper, the polymer is polyvinylpyrrolidone, the binder is polyethersulfone and the organic solvent is N,N-dimethylacetamide, a ratio of a mass of copper, a mass of polyvinylpyrrolidone, a mass of polyethersulfone and a volume of N,N-dimethylacetamide is 71 g: 7 g: 1 g: 21 mL, and the base membrane raw body is calcinated under a calcination temperature condition of 800° ° C. for 2 hours to obtain the hollow base membrane.

5. The method of preparing hollow fiber inorganic membrane according to claim 1, characterized in that, the inorganic material is titanium dioxide, the polymer is polyvinylpyrrolidone, the binder is polyethersulfone and the organic solvent is N,N-dimethylacetamide, a ratio of a mass of titanium dioxide, a mass of polyvinylpyrrolidone, a mass of polyethersulfone and a volume of N,N-dimethylacetamide is 54 g: 5 g: 1 g: 40 mL, and the base membrane raw body is calcinated under a calcination temperature condition of 850° C. for 2 hours to obtain the hollow base membrane.

6. The method of preparing hollow fiber inorganic membrane according to claim 1, characterized in that, the inorganic material is copper, iron, stainless steel, nickel or chromium, a mass fraction of copper, iron, stainless steel or nickel in the mixture of the inorganic material, the polymer, the binder and the organic solvent is greater than 70%.

7. The method of preparing hollow fiber inorganic membrane according to claim 1, characterized in that, wherein the hollow base membrane has a pore diameter of 0.4˜1 μm, a porosity of 60˜80%, an inner diameter of 1.2˜1.7 μm, and an outer diameter of 2˜3 μm.

8. The method of preparing hollow fiber inorganic membrane according to claim 1, characterized in that, the electrochemical deposition method is carried out according to the following steps:
adding 2-methylimidazole to deionized water and mixing uniformly to obtain a solution A having a ratio of a mass of 2-methylimidazole to a volume of deionized water of 4.105 g: 50 mL, and a 2-methylimidazole concentration of 50 mmol;
adding zinc acetate dihydrate to deionized water and mixing uniformly to obtain a solution B having a ratio of a mass of zinc acetate dihydrate to a volume of deionized water of 0.183 g: 10 mL, and a zinc acetate dihydrate concentration of 0.83 mmol;
mixing the solution A and the solution B and stirring for 5 seconds to obtain a ZIF-8 precursor solution;
adding the hollow base membrane and a graphite paper into the ZIF-8 precursor solution, keeping a distance between the hollow base membrane and the graphite paper at 1.5 cm, using the graphite paper as an anode, and using the hollow base membrane as a cathode, allowing reaction at a current density of 0.13 m Acm² for 30 minutes, then rinsing by using deionized water and methanol after the reaction is completed to obtain the hollow fiber inorganic membrane.

9. The method of preparing hollow fiber inorganic membrane according to claim 1, characterized in that, the sol-gel method is carried out according to the following steps:
adding aluminum triethoxide to ultrapure water at 90° C., stirring for 3 hours, adding 1M nitric acid solution, and carrying out reflux at 90° C. for 16 hours to obtain a solution C, wherein a volume ratio of the aluminum triethoxide to the ultrapure water and the nitric acid solution is 67:250:18;
adding 1M nitric acid solution and polyvinyl alcohol to ultrapure water, heating and stirring until dissolved to obtain a sol D, wherein a ratio of a volume of the nitric acid solution and the ultrapure water to a mass of polyvinyl alcohol is 5 mL: 25 mL: 3 g;
mixing the solution C and the sol D, stirring for 1 hour and then filtering to obtain a boehmite sol, wherein a volume ratio of the solution C to the sol D is 20:13;
coating the boehmite sol evenly on an outer surface of the hollow base membrane, drying at 50° C. for 24 hours, and then raising the temperature at a heating rate of 0.5° C./min to 540° C. and carrying out calcination at the temperature of 540° ° C. for 4 hours to obtain the hollow fiber inorganic membrane.

10. The method of preparing hollow fiber inorganic membrane according to claim 1, characterized in that, the chemical vapor deposition method is carried out according to the following steps:
carrying out in situ reduction of the hollow base membrane for 70 min in a mixed gas atmosphere of hydrogen and ethylene at a flow rate of 40 mL/min and at 700° C., then cooling by hydrogen at a flow rate of 20 mL/min to room temperature after the reaction is completed to obtain the hollow fiber inorganic membrane.

11. The method of preparing hollow fiber inorganic membrane according to claim 2, characterized in that, the inorganic material is stainless steel, the polymer is polyvinylpyrrolidone, the binder is polyethersulfone, and the organic solvent is N,N-dimethylacetamide, a ratio of a mass of stainless steel, a mass of polyvinylpyrrolidone, a mass of polyethersulfone and a volume of N,N-dimethylacetamide is 70 g: 1 g: 5 g: 24 mL, and the base membrane raw body is calcinated under a calcination temperature condition of 950° C. for 2 hours to obtain the hollow base membrane.

12. The method of preparing hollow fiber inorganic membrane according to claim 2, characterized in that, the inorganic material is copper, the polymer is polyvinylpyrrolidone, the binder is polyethersulfone and the organic solvent is N,N-dimethylacetamide, a ratio of a mass of copper, a mass of polyvinylpyrrolidone, a mass of polyethersulfone and a volume of N,N-dimethylacetamide is 71 g: 7 g: 1 g: 21 mL, and the base membrane raw body is calcinated under a calcination temperature condition of 800° ° C. for 2 hours to obtain the hollow base membrane.

13. The method of preparing hollow fiber inorganic membrane according to claim 2, characterized in that, the inorganic material is titanium dioxide, the polymer is polyvinylpyrrolidone, the binder is polyethersulfone and the organic solvent is N,N-dimethylacetamide, a ratio of a mass of titanium dioxide, a mass of polyvinylpyrrolidone, a mass of polyethersulfone and a volume of N,N-dimethylacetamide is 54 g: 5 g: 1 g: 40 mL, and the base membrane raw body is calcinated under a calcination temperature condition of 850° C. for 2 hours to obtain the hollow base membrane.

14. The method of preparing hollow fiber inorganic membrane according to claim 2, characterized in that, the inorganic material is copper, iron, stainless steel, nickel or chromium, a mass fraction of copper, iron, stainless steel or nickel in the mixture of the inorganic material, the polymer, the binder and the organic solvent is greater than 70%.
